(19) United States
(12) Patent Application Publication
(10) Pub. No.: US 2016/0076690 A1
(43) Pub. Date: Mar. 17, 2016

(54) Locking Cap for Fire Department Connection

(71) Applicant: AimPoint Associates, LLC, Dandridge, TN (US)

(72) Inventors: James A. Marcum, Dandridge, TN (US); Michael B. McMullen, Knoxville, TN (US)

(73) Assignee: AIMPOINT ASSOCIATES, LLC, Dandridge, TN (US)

(21) Appl. No.: 14/489,028

(22) Filed: Sep. 17, 2014

(51) Int. Cl. F16L 55/10

(52) U.S. Cl. CPC F16L 55/1026

(57) ABSTRACT

A secure inlet cap protecting the inlets of a fire department connection from blockage and damage. The secure inlet cap includes a cover and lock, each having at least one tab that engages the posts of the swivels of the fire department connection inlets. When fitted over the posts and assembled with tamper-proof fasteners, the secure inlet cap securely prevents access to the inlet. In non-emergency situations, the secure inlet cap may be removed without damage by removing the fasteners. The lock includes a tool slot receiving a tool that allows the secure inlet cap to be quickly pried loose by applying force to the fasteners. Deformable areas in the cover give way when sufficient prying force is applied breaking the hold between the fasteners and the cover and allowing the cover and the lock to be separated and removed from the swivel.

### BACKGROUND

A fire department connection (FDC) is an external access point on a building where firefighters can attach a hose to supplement a building's fire sprinkler or standpipe system during a fire. Unprotected FDCs are susceptible to blockages, damage, and theft. The large diameter openings needed for compatibility with fire hose systems and high flow volumes make unprotected FDCs susceptible to becoming blocked with trash or debris, which may impede water flow. For example, animals may nest or refuse may be inappropriately discarded in unprotected FDCs. Unprotected FDCs are also more susceptible to damage, which may make connecting a hose difficult or impossible. Brass is commonly used in FDCs because of characteristics such as corrosion resistance; however, the relative softness (i.e., malleability) of brass increases the likelihood that FDCs will be damaged, especially the threads, for example, as a result of vandalism or theft. Unfortunately, increases in the price paid for scrap metal, including brass, have turned FDCs into targets for thieves.

Various caps and plugs have been developed to protect FDCs. Early FDC caps and plugs were intended primarily to protect against blockages and damage. Like the FDCs they are designed to protect, many caps and plugs have been made of brass, which makes them theft targets as well. With theft becoming more prevalent, recent designs for FDC caps and plugs offer increased security but are not easily removed. Modern FDC caps and plugs often require special tools or keys, which are only available to firefighters, for installation and removal. While this is conducive to security, it inhibits ready access to FDCs for use in emergencies and for proper inspection and maintenance. Further, many modern FDC caps operatively engage the internal threads of the FDC and are prone to seize in the inlet rendering the FDC unusable. Finally, many modern FDC caps have emphasized security at the expense of access time, with some modern FDC caps requiring between three and seven minutes for removal. Such lengthy removal times contribute to greater property loss and increased risk to firefighters entering the burning building as a result of increasing fire temperatures while removing the FDC caps.

### BRIEF SUMMARY

Embodiments of the secure inlet cap include a cover and a lock configured to protect an inlet of a fire department connection from blockage and damage when selectively secured together by one or more fasteners. The cover and lock each have at least one tab that engages the posts on the swivels. A post opening in the first cover tab captures a first post of the swivel. A post slot in the second cover tab allows the cover to partially capture a second post when the cover is pivoted into position to block the opening of the inlet. The first cover tab and the second cover tab cooperate to prevent lateral movement of the lid when first cover tab and the second cover tab are operatively engaging the posts.

The post opening of the lock tab is positioned over the second post of the swivel, and the lock is positioned against the cover. The lock tab and the cover tabs cooperate to hold the cover in position on the swivel over the inlet when the lock tab and the cover tabs operatively engage the posts and the cover and the lock remain fastened together.

The cover includes a deformable region designed to mechanically fail and allow the fasteners to be freed from the cover so as to destructively separate the cover and lock for rapid access to the inlet when a substantially perpendicular force to the cover is applied to the deformable region.

### BRIEF DESCRIPTION OF THE DRAWINGS

Further features, aspects, and advantages of the present disclosure will become better understood by reference to the following figures, wherein elements are not to scale so as to more clearly show the details and wherein like reference numbers indicate like elements throughout the several views:

FIG. 1 illustrates one embodiment of the secure inlet cap installed on swivels of a fire department connection;

FIG. 2A is a bottom plan view of one embodiment of the cover of the secure inlet cap;

FIG. 2B is a front elevation view of one embodiment of the cover of the secure inlet cap;

FIG. 2C is a rear elevation view of one embodiment of the cover of the secure inlet cap;

FIG. 2D is a side elevation view of one embodiment of the cover of the secure inlet cap, the left side elevation view being a mirror image thereof;

FIG. 3A is a top plan view of one embodiment of the lock of the secure inlet cap;

FIG. 3B is a front elevation view of one embodiment of the lock of the secure inlet cap, in partial section taken along section line 3B;

FIG. 3C is a side elevation view of one embodiment of the lock of the secure inlet cap, in partial section taken along section line 3C;

FIG. 3D is a bottom plan view of one embodiment of the lock of the secure inlet cap;

FIG. 3E is a rear elevation view of one embodiment of the lock of the secure inlet cap;

FIG. 3F is a perspective view of one embodiment of the lock of the secure inlet cap;

FIG. 4A is an exploded perspective view of the secure inlet cap in relation to a fire department connection swivel;

FIG. 4B is an exploded perspective view of the secure inlet cap with the cover fitted on the fire department connection swivel featuring the first cover tab;

FIG. 4C is an exploded perspective view of the secure inlet cap with the cover fitted on the fire department connection swivel featuring the second cover tab;

FIG. 4D is a perspective view of the secure inlet cap fitted on the fire department connection swivel featuring the first cover tab; and

FIG. 4E is a perspective view of the secure inlet cap fitted on the fire department connection swivel featuring the second cover tab.

### DETAILED DESCRIPTION

Embodiments of a secure inlet cap are described herein and illustrated in the accompanying figures. The secure inlet cap protects the inlets of a fire department connection from blockage and damage. The secure inlet cap includes a cover and lock, each having at least one tab that engages the posts of the swivels of the fire department connection inlets. When fitted over the posts and assembled with tamper-proof fasteners, the secure inlet cap securely prevents access to the inlet. In non-emergency situations, the secure inlet cap may be removed without damage by removing the fasteners. The lock includes a tool slot receiving a tool that allows the secure inlet cap to be quickly pried loose by applying force to the fasteners. Deformable areas in the cover give way when sufficient prying force (i.e., a genuine effort) is applied breaking the hold between the fasteners and the cover and allowing the cover and the lock to be separated and removed from the swivel.

The secure inlet cap meets the requirements of standard, local, or state fire codes (e.g., International Fire Code or the National Fire Protection Association Code) or building codes (e.g., International Building Code). Compared to the keyed fire department connection caps, which requires key owners, typically senior fire fighters and fire marshals, to be present for installation and removal when installing, inspecting, maintaining, or utilizing the fire department connection, the secure inlet cap provides rapid removal in the event of a fire and may be installed or removed by non-fighters when installing, inspecting, and servicing a building fire protection system (e.g., sprinkler and standpipe systems), while still offering protection of the fire department connection inlets and swivels. Faster removal means lower fire temperatures that firefighters must face when entering a building on fire and potential reductions in property losses resulting from firefighters being able to supplement the building fire protection system sooner. Less restricted access means reduced costs for the municipality because key owners are not required to be present for all inspections and maintenance and means building fire protection systems may be properly inspected and serviced as required by fire and/or building codes, even when key owners are not available (e.g., responding to a fire or other emergency).

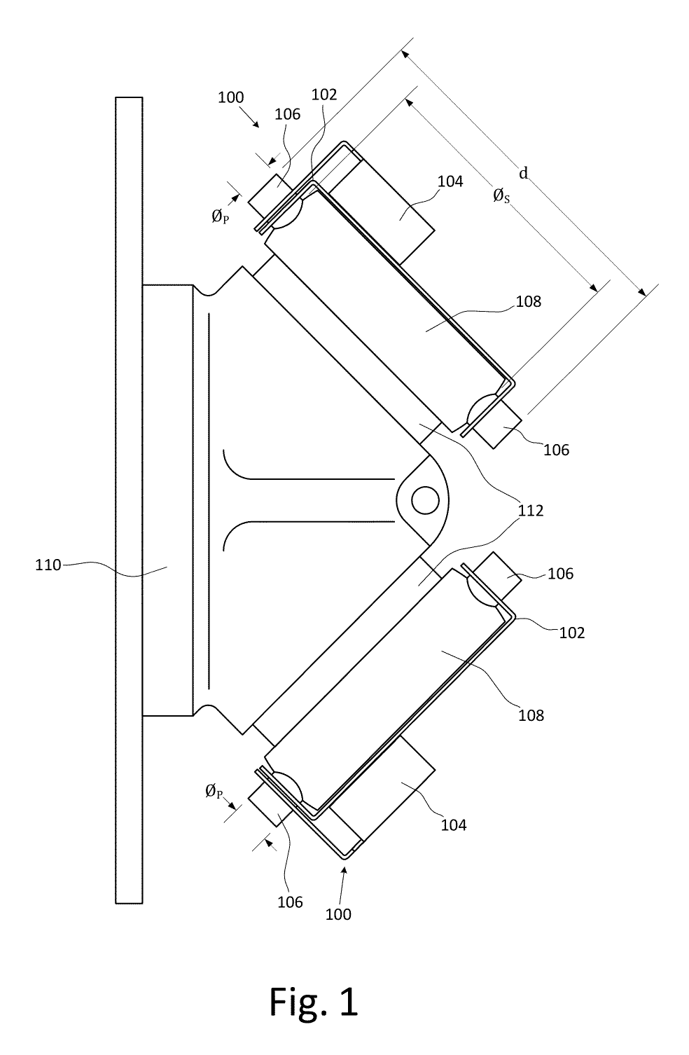

FIG. 1 illustrates one embodiment of the secure inlet cap installed on swivels of a fire department connection. Each secure inlet cap 100 has a cover 102 and a lock 104. In the illustrated embodiment, each secure inlet cap 100 is secured to a pair of diametrically opposed posts 106 on a swivel 108 of a fire department connection 110 with two inlets 112. Each swivel has an outer diameter Ø_{S} and a distance d between the ends of the posts.

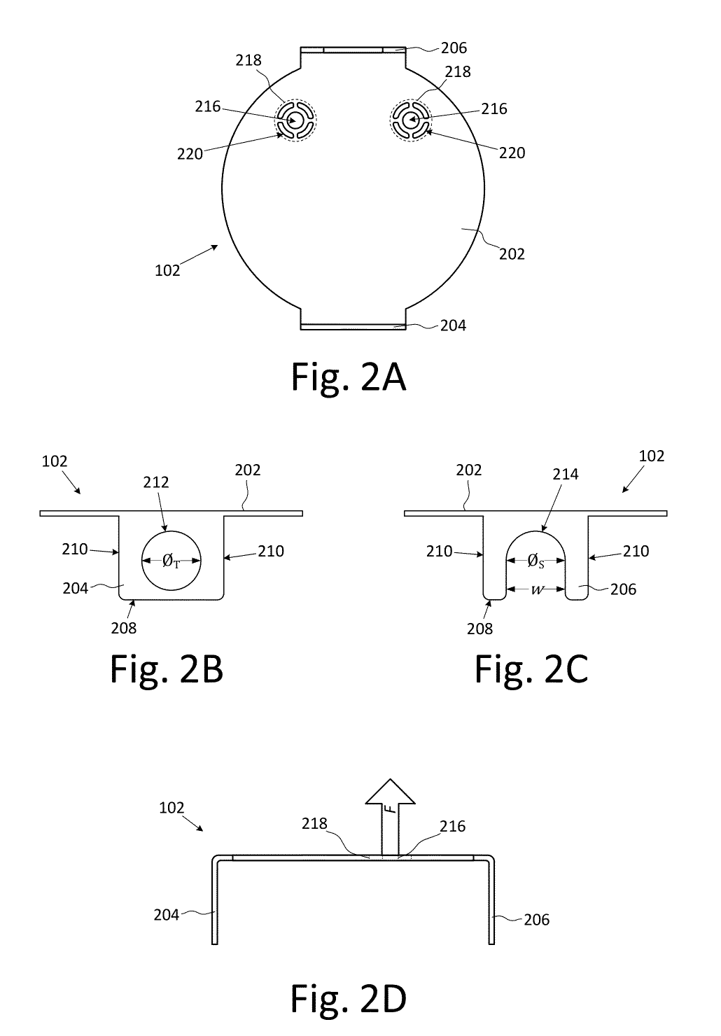

FIGS. 2A through 2D are bottom plan, front elevation, rear elevation, and side elevation views, respectively, of one embodiment of the cover of the secure inlet cap. The top plan view is substantially identical to the bottom plan view except the tabs are not visible. The left side view and the right side view are mirror images of each other. The cover 102 includes a lid 202 and two tabs 204, 206. The lid 202 is a plate dimensioned to cover the opening of a swivel of a fire department connection. In various embodiments, the lid 202 is substantially flat and circular plate with a diameter generally corresponding to the diameter of the FDC, which typically ranges from approximately 38.1 mm (1.5 in) to approximately 127 mm (5 in). Because the secure inlet cap is mounted externally against the lip of the inlet and not inserted into the inlet and does not engage the threads of the swivel, the secure inlet cap does not seize in place rendering the fire department connection unusable when needed, even when proper inspection and maintenance is not performed. The tabs 204, 206 are substantially orthogonal to the top of the lid 202. The tabs 204, 206 define a bottom edge 208, which is distally located from the lid 202, and side edges 210.

The first tab 204 defines a post opening 212 bounded on all sides. The post opening 212 is a through-opening dimensioned to receive a post 106 of the swivel 108 with some play. In other words, the post opening 212 is slightly larger than the diameter Ø_{P} of the posts 106 on the swivel 108. In various embodiments, the diameter Ø_{C} of the post opening 212 may be between approximately 5% and approximately 35% larger than the diameter Ø_{P} of the posts 106 on the swivel 108. For example, the diameter of the post opening 212 may be larger than the diameter of a swivel post by approximately 5%, approximately 20%, approximately 25%, approximately 20%, approximately 25%, approximately 30%, or approximately 35%.

The second tab 206 defines a post slot 214 that opens to one edge of the second tab 206. In other words, the post slot 214 may be bounded on three sides. In the illustrated embodiment, the post slot 214 opens to the bottom edge 208 of the second tab 206; however, the post slot 214 may open to either side edge 210 without departing from scope and spirit of the present invention. The post slot 214 is dimensioned similarly to the post opening 212 with the diameter Ø_{S} and width w of the post opening 212 being larger than the diameter Ø_{P} of the posts 106 on the swivel 108 by approximately 5% to approximately 35%. For example, the diameter and width of the post slot 214 may be larger than the diameter Ø_{P} of the posts 106 on the swivel 108 by approximately 5%, approximately 20%, approximately 25%, approximately 20%, approximately 25%, approximately 30%, or approximately 35%.

The lid 202 defines one or more fastener openings 216 that operably engage a fastener, such as a threaded fastener (e.g., a bolt or screw). The lid 202 includes a deformable region 218 proximate to the fastener openings 216. The deformable region 218 structurally weakens the lid 202 proximate to the fastener openings 216. In other words, the deformable region 218 is designed to mechanically fail under stress resulting from a genuine effort to break (i.e., destructively remove) the secure inlet cap 100, while the remainder of the cover 102 remains structurally intact. The failure of the deformable region may occur through any of a variety of mechanical failure modes including, but not limited to, mechanical overload, fatigue, yielding, and fracture.

When a force F substantially perpendicular to the top of the lid 202 is applied to the deformable region 218, the deformable region mechanically fails as designed allowing the fasteners to be freed from the lid 202. In some embodiments, deformable region may expand the diameter of the fastener openings 216 allowing the fasteners to be pulled free from the fastener openings 216 with little to no resistance. In other embodiments, deformable region may separate the portion of the lid 202 defining the fastener openings 216 from the remainder of the lid 202 so the fasteners are no longer secured to the lid.

Each deformable region 218 may encompass one or more fastener openings 216. In some embodiments, each fastener opening 216 is bounded by a deformable region 218. In other embodiments, a single deformable region 218 bounds all fastener openings 216. The deformable region 218 may include one or more perforations 220 defined by the lid 202. In the illustrated embodiment, the perforations 220 are a series of arcuate slots around each fastener opening 216. Examples of other constructions for the deformable region 218 include, without limitation, linear slots extending radially from the fastener openings 216 and multiple small holes through the lid 202 in the deformable region 218. By adjusting the characteristics of the deformable region, such as, but not limited to, the amount of material removed, the number of perforations, the shapes of the perforations, the spacing of the perforations relative to the fastener opening, the amount of force required to break the cover 102 and the lock 104 apart may be set. In various embodiments, the minimum applied force causing failure in the deformable region 218 and pry the lock 104 from the cover 102 may be approximately 178 N (40 lbf). It has been determined that a minimum applied force suitable to prevent most accidental contact or unintentional/casual manual efforts from dislodging the secure inlet cap 100 but still allowing removal by a genuine effort manually applied by a firefighter using a smaller (e.g., approximately 18 in) pry bar in an emergency may range from approximately 245 N (55 lbf) to approximately 289 N (65 lbf). To provide a frame of reference, applied forces in this range are typical of the low end of recommended wheel lug nut torque specifications. The deformable region 218 may be configured to fail under a greater minimum applied force of up to approximately 445 N (100 lbf) or more. However, increasing the minimum applied force may require use of larger (approximately 30 in, or greater) pry bars and/or greater strength to manually remove the secure inlet cap 100.

Embodiments of the cover may include one or more flanges, ridges, lips, or other projections that may be used to align the cover with the opening of the swivel or the lock 104 or to enhance the seal between the cover and the opening of the swivel. For example, the lid 202 may include one or more concentric ridges that are fit inside and/or outside the lip of the swivel. Embodiments may include a gasket to enhance the seal formed between the cover and the opening of the swivel.

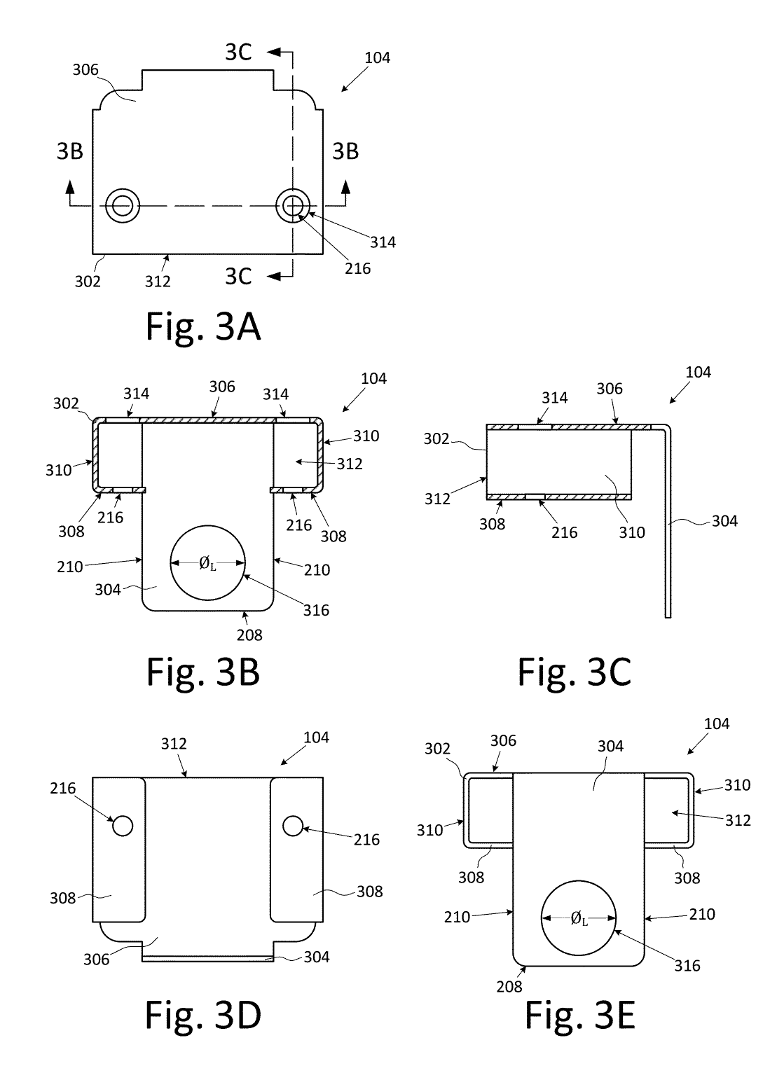

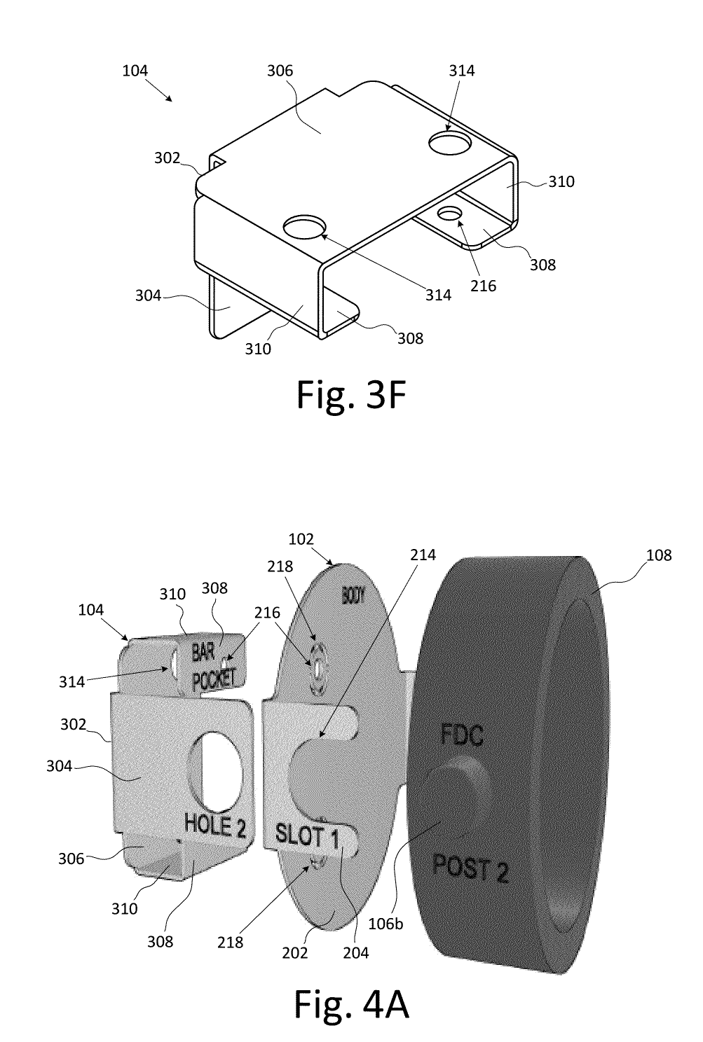

FIGS. 3A through 3F are top plan, front elevation, side elevation, bottom plan, rear elevation, and perspective views, respectively, of one embodiment of the cover of the fire department connection lock. The left side view and the right side view are mirror images of each other. Generally, the lock 104 includes a frame 302 and a tab 304.

The frame 302 has a top plate 306, bottom flanges 308, and opposing side walls 310 joining the top plate 306 and the bottom flanges 308. The flanges 308 are substantially parallel to the top plate 306. In the illustrated embodiment, the flanges 308 project inwardly to give the frame 302 a substantially C-shaped cross section; however, the flanges may also project outwardly. The frame 302 defines a tool access port 310 dimensioned to receive the end of a lever that may be used to apply a prying force. Examples of such tools include, but are not limited to, demolition bars, forcible entry tools, Halligan bars, and other tools routinely carried by firefighters. For convenience, such tools may be referred to herein as pry bars.

When the secure inlet cap is assembled, the flanges 308 are designed to rest on, mate with, or otherwise engage the lid 202 of the cover 102. The flanges 308 define fastener openings 216 that operatively engage the fasteners. The fastener openings 216 defined by the flanges 308 and the lid 202 are similarly dimensioned with a diameter corresponding to a selected fastener size. The top plate 306 defines fastener passages 312 corresponding to that provide access to the fastener openings 216 in the flanges 308. The fastener passages 312 have dimensions large enough to allow unrestricted passage of the fastener, including the fastener head, and the operative portion of the corresponding fastener tool (e.g., a socket, wrench, or screwdriver). In various embodiments, the fasteners are tamper-proof fasteners (e.g., tamper-proof bolts or tamper-proof screws) or other security fasteners.

The lock tab 304 is substantially similar to the first tab 204 of the cover 102. The lock tab 304 is substantially orthogonal to the top plate 306. The lock tab 304 defines a bottom edge 208, which is distally located from the top plate 306, side edges 210, and a post opening 316 bounded on all sides. The post opening 316 is a through-opening dimensioned to receive a post 106 of the swivel 108. The diameter Ø_{L} of the lock tab post opening 316 may be slightly larger than the diameter Ø_{P} of the swivel posts 106, as previously described in relation to the first lid tab post opening 212.

The secure inlet cap 100 is fabricated from materials that provide sufficient strength to resist mechanical failure under most forces that may be applied by a human using a manually operated pry bar except in the deformation region 218. Specifically, the frame 302 has sufficient strength to carry a force sufficient to cause operative mechanical failure of the deformation region 218 applied using the pry bar and transfer that force to the fasteners without experiencing meaningful deformation or damage. Similarly, the lid 202 has sufficient strength to support the pry bar and serve as a fulcrum while that force is applied without meaningful deformation or damage. Embodiments of the secure inlet cap 100 may incorporate structural supports that enhance the basic material strength to provide sufficient overall strength. For example, ribs or flanges may be added to the lid to improve the strength of the secure inlet cap 100.

Because of exposure to a wide range of environmental conditions, the materials used to fabricate the secure inlet cap 100 may also minimize mechanical failures due to corrosion, wear (i.e., erosion), thermal shock, as well as to minimize the effect of temperature on the strength of the secure inlet cap 100. Examples of suitable materials include, without limitation, various metals (e.g., stainless steel or brass) and plastics. To discourage theft, materials with low scrap value may be selected. Other considerations may include selecting materials that are not reactive with the materials to fabricate components of the fire department connection 110 to minimize or reduce the likelihood that the secure inlet cap 100 will bond to the fire department connection 110 and become difficult to remove as intended.

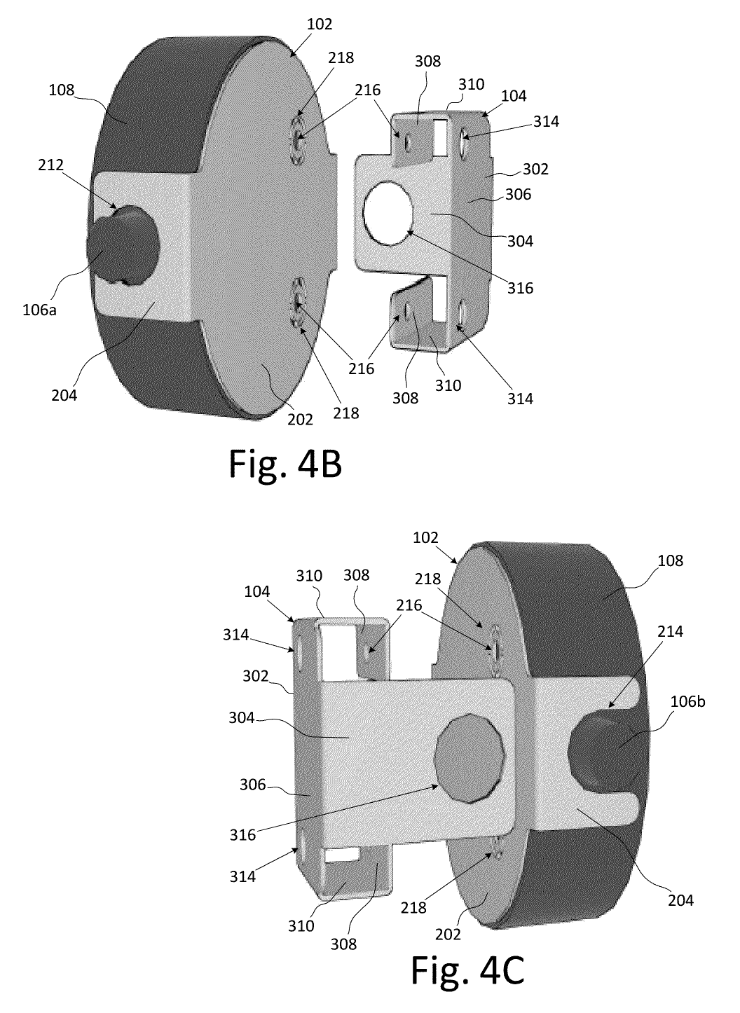

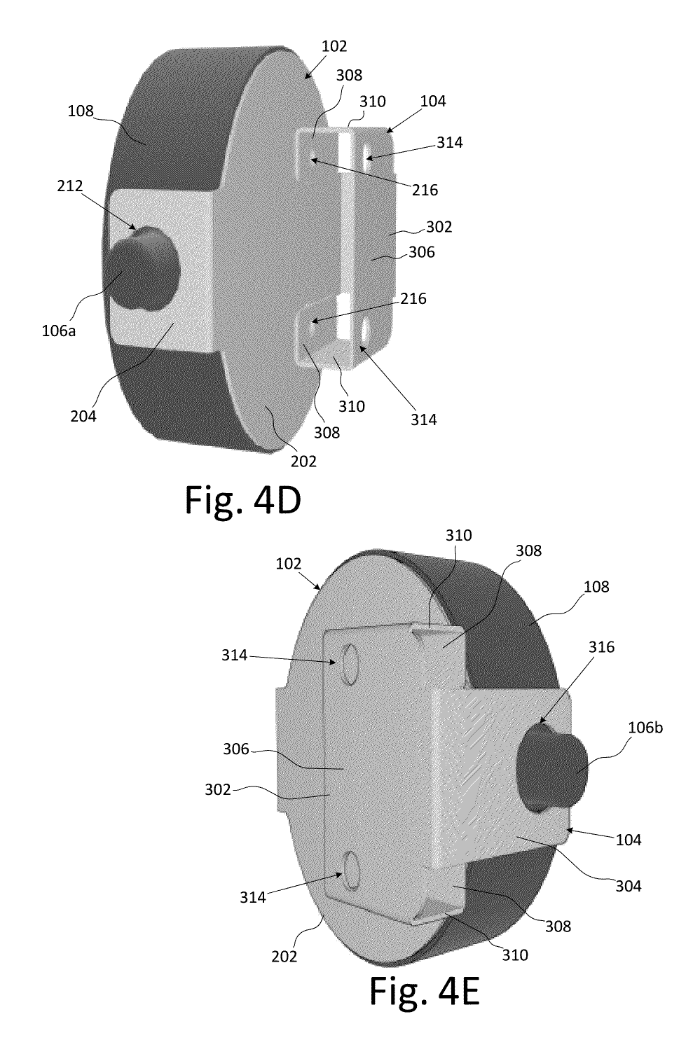

FIG. 4A is an exploded perspective view of the secure inlet cap in relation to a fire department connection swivel. FIGS. 4B to 4E illustrate the attachment of the secure inlet cap to a fire department connection swivel. In use, the post opening 212 of the first cover tab 204 is positioned over a first post 106a of the swivel 108. The distance between the first tab 204 and the second tab 206 is greater than the swivel outer diameter Ø_{S} and less than the distance d between the ends of the posts. The post slot 214 of the second cover tab 206 allows the cover 102 to partially capture a second post 106b when the lid 202 is pivoted into position so as to block the opening of the inlet 112 after the first cover tab 204 captures the first post 106a. The first cover tab 204 and the second cover tab 206 cooperate to prevent lateral movement of the cover 102 when first cover tab 204 and the second cover tab 206 are operatively engaging the posts 106a, 106b.

The post opening 309 of the lock tab 304 is positioned over the second post 106b of the swivel 108, and the lock frame 302 is positioned against the lid 202. The fastener opening 216 of the lock frame 302 is located so as to be aligned with the fastener opening 216 of the lid 202 when the lock tab 304 surrounds the second post 106b. Fasteners are installed to secure the lock 104 to the cover 102. Once the cover 102 and the lock 104 are secured together, the positions of the first cover tab 204 and the lock tab 304 are fixed. The lock tab 304 and the cover tabs 204, 206 cooperate to hold the cover 102 in position on the swivel over the inlet 112 when the lock tab 304 and the cover tabs 204, 206 operatively engage the posts 106a, 106b and the lock 104 is secured to the cover 102. The posts 106a, 106b captured by the post opening 212 of the first cover tab 204 and the post opening 316 of the lock tab 304 hold the secure inlet cap 100 in position while the cover 102 and the lock 104 remain fastened together.

On average, the deformable region allows the secure inlet cap to be removed in less than 30 seconds in an emergency, which translates into a removal time that is approximately six to fourteen times faster than the removal time for many modern FDC caps, which may take between three and seven minutes to remove.

The description and illustration of one or more embodiments provided in this application are intended to provide a complete thorough and complete disclosure the full scope of the subject matter to those skilled in the art and not intended to limit or restrict the scope of the invention as claimed in any way. The embodiments, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A secure inlet cap for use with a fire department connection swivel having diametrically opposed posts, the secure inlet cap comprising:
a cover comprising a lid and a cover tab, the cover tab defining a through-opening dimensioned to receive a first post of the fire department connection swivel, the lid defining a first fastener opening and a deformable region proximate to the fastener opening;
a lock comprising a frame and a lock tab, the lock tab defining a through-opening dimensioned to receive a second post of the fire department connection swivel, the frame defining a second fastener opening located to align with the first fastener opening when the cover is positioned with cover tab capturing the first post and the lock is positioned with the lock tab capturing the second post, the frame forming a tool access port transferring a prying force applied using a lever engaging the tool access port to the deformable region via a fastener operative securing the lock to the cover; and
a fastener selectively securing the lock to the cover;
wherein the deformable region is designed to mechanically fail and allow the cover to become unfastened from the lock when a genuine effort is applied.

2. The secure inlet cap of claim 1 wherein a genuine effort requires a minimum applied force of approximately 245 N (55 lbf) to approximately 289 N (65 lbf).

3. The secure inlet cap of claim 1 wherein deformable region deforms to enlarge the first fastener opening and release the fastener when a genuine effort is applied.

4. The secure inlet cap of claim 1 wherein the frame has a substantially “C”-shaped cross section.

5. The secure inlet cap of claim 1 wherein the fastener is a tamper-proof fastener selectively releasably engaging the first fastener opening and the second fastener opening.

6. The secure inlet cap of claim 1 wherein the cover further comprises a second cover tab located diametrically opposite to the first cover tab, the second cover tab defining a slot opening away from the lid and dimensioned to receive the second post.

7. The secure inlet cap of claim 6 wherein the first cover tab and the second cover tab extend are oriented substantially perpendicular to the lid.

8. The secure inlet cap of claim 1 wherein the deformable region comprises a portion of the lid around the first fastener opening defining a plurality of through-openings.

9. The secure inlet cap of claim 8 wherein the plurality of through-openings comprise a series of arcuate slots substantially concentric with the first fastener opening, the portion of the lid between the ends of the arcuate slots dimensioned to mechanically fail when a force of at least approximately 245 N (55 lbf) is applied perpendicular to the lid in the deformable region.

10. The secure inlet cap of claim 1 wherein a force applied to the frame is transferred to the deformable region via the fastener.

11. A secure inlet cap for use with a fire department connection swivel defining an inlet, the swivel having an outer diameter, diametrically opposed posts, and a distance between the post ends, the secure inlet cap comprising:
a cover comprising a lid, a first tab, and a second tab, the first tab and the second tab separated by a distance greater than the outer diameter of the swivel and less than the distance between the post ends, the first tab defining an opening for surrounding a first post to secure one side of the cover to the swivel, the second tab defining an opening receiving the second post as the lid is pivoted into place to block the swivel after the first tab opening captures the first post, the first tab and the second tab cooperating to prevent lateral movement of the lid when operatively engaging the posts, the lid defining a fastener opening and a deformable region proximate to the fastener opening, the deformable region comprising a plurality of openings defined by the lid removing sufficient material to allow the deformable region to mechanically fail when a selected minimum perpendicular force is applied to the deformable region;
a lock comprising a frame and lock tab, the frame defining a fastener opening and a tool slot, the lock tab defining an opening for surrounding the second post, the frame fastener opening positioned to align with the lid fastener opening when the lock tab surrounds the second post, the lock being securable to the cover when a fastener is operatively received by the lid fastener opening and the lock fastener opening, the lock tab and the cover tabs cooperating cooperate to hold the cover in position on the swivel when the lock tab and the cover tabs operatively engage the posts and the lock is secured to the cover; and
a fastener selectively securing the lock to the cover.

12. The secure inlet cap of claim 11 wherein the selected minimum perpendicular force is approximately 245 N (55 lbf) to approximately 289 N (65 lbf).

13. The secure inlet cap of claim 11 wherein the fastener is a tamper-proof fastener operatively engaging the first fastener opening and the second fastener opening.

14. The secure inlet cap of claim 11 wherein the first cover tab and the second cover tab extend are oriented substantially perpendicular to the lid.

15. The secure inlet cap of claim 11 wherein the deformable region comprises a portion of the lid around the first fastener opening defining a plurality of perforations.

16. The secure inlet cap of claim 15 wherein the plurality of perforations comprise a series of arcuate slots substantially concentric with the first fastener opening, the portion of the lid between the ends of the arcuate slots dimensioned to mechanically fail when a force of at least approximately 245 N (55 lbf) is applied perpendicular to the lid in the deformable region.

17. The secure inlet cap of claim 11 wherein the fastener transfers a force applied to the frame to the deformable region as a perpendicular force.

18. A secure inlet cap for use with a fire department connection swivel having diametrically opposed posts, the secure inlet cap comprising:
a cover comprising a lid, a first tab, and a second tab, the first tab diametrically opposed to the second tab, the first tab and the second tab extending away from the lid in the same direction, the first tab and the second tab being substantially perpendicular to the cover, the first tab defining a through-opening dimensioned to receive a post of the fire department connection swivel, the first tab having a closed end distally located from the lid, the second tab defining a slot opening to the end distally located from the lid and dimensioned to receive a post of the fire department connection swivel, the lid defining a fastener opening dimensioned to receive a fastener, the lid defining a deformable region proximate to the fastener opening, the deformable region deforming to enlarge the fastener opening when a genuine effort is applied; and
a lock comprising a frame and a tab; the lock tab defining a through-opening dimensioned to receive a post of the fire department connection swivel, the lock tab extending away from the frame, the lock tab having a closed end distally located from the frame, the frame defining a fastener opening dimensioned to receive a fastener, the lock fastener opening aligning with the cover fastener opening when the lock tab through-opening captures the same swivel engaged by the cover second tab slot, the lock securable to the cover by a tamper-proof fastener and cooperating with the cover to capture opposing posts of the fire department connection swivel; the frame forming a tool access port dimensioned to receive a pry bar end and receive a prying force applied using the pry bar, the frame transferring the prying force to the deformable region for destructively separating the lock from the cover for quick removal of the secure inlet cap from the fire department swivel in emergency situations, the secure fastener being removable to non-destructively separate the lock from the cover for removal of the secure inlet cap from the fire department swivel in non-emergency situations; and
a fastener selectively securing the lock to the cover.

19. The secure inlet cap of claim 18 wherein a genuine effort requires a minimum applied force of approximately 245 N (55 lbf) to approximately 289 N (65 lbf).

20. The secure inlet cap of claim 18 wherein the deformable region comprises a portion of the lid around the first fastener opening defining a plurality of through-openings.
